(19) United States
(12) Patent Application Publication
(10) Pub. No.: US 2004/0043167 A1
(43) Pub. Date: Mar. 4, 2004

(54) Failure-resistant receptacle and method of manufacture

(76) Inventors: Gianni Holzem, Neenah, WI (US); Scott Allan Idlas, Appleton, WI (US)

Correspondence Address: BEMIS COMPANY, INC., 2200 BADGER AVENUE, OSHKOSH, WI, 54904, US

(21) Appl. No.: 10/234,286

(22) Filed: Sep. 4, 2002

(51) Int. Cl. B32B 1/02; B32B 31/00; B32B 1/08

(52) U.S. Cl. 428/34.9; 428/35.2; 156/269; 156/275.1; 156/272.6

(57) ABSTRACT

The present invention involves a failure resistant receptacle of a puncture-resistant rollstock or bag including an inner bag formed from a seamless tube of material e.g. a lay-flat tube member having a first tube wall and an opposed second tube wall and having a first tube edge, an opposed second tube edge, a first tube end and an opposed second tube end where the first and second tube walls define a product receiving chamber and further having first and second outer film members affixed to opposing outer surfaces respectively of the first and second tube walls and extending continuously between the first and second tube ends. Optionally, the first and/or second outer film members may be narrower, coextensive, or extend beyond one or both of the first and second tube edges of the lay-flat tube member. In a bag embodiment a lateral seal is provided through the first and second tube walls and the first and second outer film members and extends laterally across the width of at least the lay-flat tube member. Methods of manufacturing such rollstock and bags are also disclosed.

### BACKGROUND OF THE INVENTION

The present invention relates to the packaging of bone-in cuts of meat and more particularly to a bag and the method of forming the bag for packaging such meat cuts in bag arrangement which decreases the likelihood of a bone puncturing through the bag.

The use of bags formed of a plastic film for packaging primal and sub-primal cuts of meat is well known in the art. In use, the cut of meat is loaded into the bag. The bag is evacuated to remove air so the bag collapses against the cut of meat and then it is heat sealed to maintain the evacuation. In many instances, the bag is formed of a heat-shrinkable thermoplastic film. When heat-shrinkable bags are used, after evacuation and sealing, the bag is exposed briefly to hot water at about 90° C. or other heating means causing the bag to shrink and form fit the cut of meat. Packaging in this fashion excludes air from the package to prolong shelf life, reduces weight loss due to drying of the meat, reduces spoilage should a puncture occur, and provides an aesthetically pleasing package.

Heat shrinkable bag film is typically thin and usually not more than about 3 to 4 mils (0.076 to 0.10 mm) thick. Accordingly, these thin bags generally are not suitable for packaging cuts of meat which contain sharp projecting bones. For example, the ribs or other sharp bone protrusions as contained by rib beef cuts or pork loins and other meat cuts may puncture the bag during the evacuation of air or during heat shrinking as the bag draws tightly about the bone-in meat cut. Any puncture in the bag is undesirable as it allows the meat in the bag to be exposed to the air. The puncture is also a possible source of contamination. The problem of bone punctures is compounded by abrasion during movement of the package along a conveyer and as it is loaded into corrugated boxes for shipping. Abrasion between adjacent packages caused by vibration and movement of the meat packages one against another, during transport and handling, also increases the likelihood of bone punctures.

One technique for preventing bone punctures is to overlay the protruding bones of the cut of meat with paper, cloth or a wax impregnated cloth prior to insertion into the bag. This is shown, for example, in U.S. Pat. No. 2,891,870. Another common solution is to improve the puncture and abrasion resistance of the bag film by adhering a patch to the outer surface of the heat-shrinkable bag. U.S. Pat. No. 4,755,403 discloses use of an oriented heat-shrinkable patch affixed by an adhesive to the surface of a heat-shrinkable bag and U.S. Pat. No. 5,302,402 discloses a non oriented patch adhered to the bag surface by corona treatment. In order to provide the bag with greater protection, U.S. Pat. No. 5,545,419 discloses adhering two heat-shrinkable patches to the bag, one to each outer surface of the flattened bag.

Neither the cloth nor paper overlay nor a patch adhered to the outer surface of the bag are entirely acceptable solutions to the problem of preventing bone punctures and providing abrasion resistance. One reason for this is that the overlay may be dislocated from its laid-on position as the bone-in cut of meat is inserted into a bag. Patch-bags do not provide continuous protection from the mouth of the bag to the bottom. Thus, patch-bags require some manipulation of the heavy cut of meat to insure that the patch is properly oriented over the protruding bones. Patch bags require a thin neck region that is not “covered” by a puncture-resistant film, thereby creating a potential for bone punctures. These “neck” regions may be several inches in length and although the prior art patch bags have a defined width designed for the particular cut of meat that is to be packaged, the ultimate length of the finally sealed bag is determined by the position of the final lateral seal placed within the “neck” region. Variation in product size and placement may cause a portion of the product to be unprotected, as may generally occur when operators are working at high production speeds, and an “uncovered” region is left between the final lateral seal and the patch. Another drawback of patch bags is the cost of manufacturing the separate patches and the added cost of having to laminate one or more patches to the bag. Due to the large number of bag sizes required by the meat packaging industry, the patch-bag manufacturers are required to produce different sizes of patches for the different sizes of bags, which in turn adds to the manufacturing costs associated therewith. In the bag manufacturing process, patches are applied intermittently to the bag film and the equipment to perform this is complicated, expensive, unique and difficult to maintain. Disadvantageously, waste is high in the manufacturing process of making patch bags, especially at start-up, due in part to the requirement for precise intermittent placement of the patches. There is also a great deal of set up time required to change and adjust proper placement of the patches to bags in order to accommodate varying products.

Attempts to avoid applying a patch to the bag have included manufacturing the bag with multiple plies along one side to provide bone puncture resistance. For example, U.S. Pat. Nos. 4,704,101 and 5,020,922 disclose heat sealing a wide area of a laid flat tubing to itself to form a double thickness, corona treating one flattened side and then folding the tubing so that the double thickness overlays one of the flatted sides. This forms a triple ply along one side of the bag and a single ply along an opposite side wherein all the adjacent surfaces of the three ply side are interfacially bonded. U.S. Pat. No. 4,481,669 discloses inserting a narrow longitudinally folded web into a wider longitudinally folded web and then heat sealing across the webs to form side sealed bags which have a single thickness adjacent the bag mouth while the rest of the bag has a double thickness. U.S. Pat. Nos. 6,015,235 and 6,206,569 discloses puncture-resistant barrier pouches having a thick-walled body portion and a thin-walled neck portion that extends outwardly from an open end of the body portion in side-sealed bags.

Accordingly, it is an object of the present invention to provide an improved bag structure and method of manufacturing the improved bag structure.

### SUMMARY OF THE INVENTION

The present invention involves a failure resistant receptacle such as a puncture-resistant bag including an inner bag formed from a seamless tube of material. The puncture-resistant bag includes a tube member having a first tube wall and an opposed second tube wall. The tube member includes a first tube edge, an opposed second tube edge, a first tube end and an opposed second tube end. The first and second tube walls define a product receiving chamber. A first outer film member is affixed to an outer surface of the first tube wall and extends continuously between the first and second tube ends. Optionally, the first outer film member may laterally extend beyond one or both of the first and second tube edges of the tube member or may be coextensive with one or both edges, or may be narrower than one or both edges. A second outer film member is affixed to an outer surface of the second tube wall and extends continuously between the first and second tube ends. Optionally, the second outer film member may laterally extend beyond one or both of the first and second tube edges of the tube member, or may be coextensive with one or both edges, or may be narrower than one or both edges. In one embodiment of the invention when both outer film members have side edges narrower than either the first or second or both edges of the tube member, the side edges of the first and second outer members are slightly offset from one another in the lay-flat position to facilitate sealing by diminishing the transitional differential in thickness between the lay-flat tube and the outer film members. A first lateral seal is provided through the first and second tube walls and the first and second outer film members. The first lateral seal extends laterally across the width of at least the tube member. The tube member may be a flexible tubular film or sheet which may be collapsed to a lay-flat condition for ease of manufacture and processing. Also disclosed are methods for manufacturing such a bag.

Other details, objects, and advantages of the invention will become apparent from the following detailed description and the accompanying drawing figures of certain embodiments thereof.

### DESCRIPTION OF THE DRAWINGS

A more complete understanding of the invention can be obtained by considering the following detailed description in conjunction with the accompanying drawings, in which:

FIG. 1 is a plan view of a preferred embodiment illustrating a puncture-resistant bag in a substantially lay-flat presentation.

FIG. 2 is a cross-sectional view of the bag depicted in FIG. 1, taken through section 2-2 of FIG. 1.

FIG. 3 is a cross-sectional view of the bag depicted in FIG. 1, taken through section 3-3 of FIG. 1.

FIG. 4 is a perspective view of a simplified method of affixing outer film members to lay-flat tube member.

FIG. 5 is a plan view of another embodiment illustrating a puncture-resistant bag in a substantially lay-flat presentation.

FIG. 6 is a cross-sectional view of the bag depicted in FIG. 5, taken through section 6-6 of FIG. 5.

FIG. 7 is a cross-section illustration of a preferred composite film structure.

FIG. 8 is a schematic representation of a preferred method of manufacturing films for use with the present invention.

FIG. 9 is schematically depicting a system for manufacturing the puncture-resistant of FIGS. 1 and 5.

### DETAILED DESCRIPTION OF THE PREFERRED EMBODIMENTS

While the present invention will be described fully hereinafter with reference to the accompanying drawings, in which particular embodiments are shown, it is to be understood at the outset that persons skilled in the art may modify the invention herein described while still achieving the desired result of this invention. Accordingly, the description that follows is to be understood as a broad informative disclosure directed to persons skilled in the appropriate art and not as limitations of the present invention. The drawings are not to scale, but are illustrative of the invention. The term “film” as it is used herein means film or foil and includes polymeric films such as thermoplastic films which optionally may be metallized or unmetallized, and metal foils such as aluminum foil.

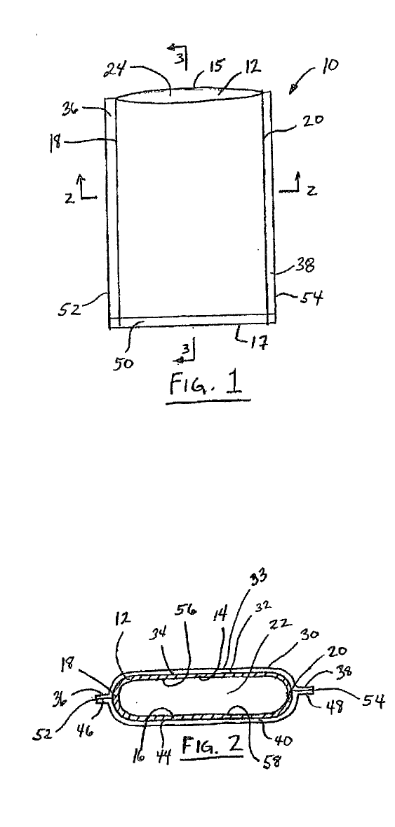

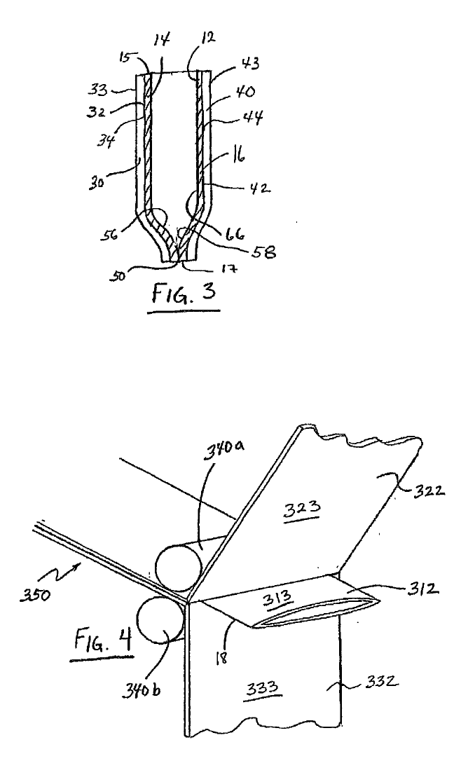

Referring to the drawings, FIGS. 1-3 illustrate a preferred bag generally indicated at 10. FIG. 1 is a side view of bag 10, while FIGS. 2 and 3 are cross-sectional views of FIG. 1 taken along lines 2-2 and 3-3 respectively. Viewing FIGS. 1, 2 and 3 together, the bag 10 includes a tube member 12 suitable for processing in a lay-flat condition and having a first tube wall 14, an opposed second tube wall 16, a first tube end 15 and an opposed second tube end 17, when the bag 10 is in its lay-flat orientation. The tube member 12 may be referred to as the “bag film” and is generally formed by collapsing a tubular film to its flat width. A collapsed tube has a “machine direction,” or length, that runs parallel to the central axis of the tube and a “transverse direction,” or width, that runs perpendicular to the central axis of the tube. The first and second tube walls 14 and 16 define a product receiving chamber 22 and an open mouth 24. A first tube edge 18 and an opposed second tube edge 20 are seamless and are formed when the tubular bag film is collapsed to form the tube member 12.

The bag 10 includes a first outer film member 30 affixed to an outer surface 34 of the first tube wall 14 to provide further mechanical properties, specifically abrasion-resistant and/or puncture-resistance, to the lay-flat tube member. As used herein, the term “affixed” encompasses those methods used in the art to bond together two or more layers of film or other material. Advantageously, the bond interface should have sufficient physical strength to withstand the tension resulting from stretching or shrinking around the food body sealed within the bag 10. The bonding processes specifically include surface energy treatments, such as corona discharge, plasma treatment, adhesive lamination and extrusion lamination among others. Advantageously, fusion bonding such as heat fusion e.g. by heat seals, need not be used to affix either or both first and second outer members 30, 40 to the tube member 12 or each other although it is an optional method of attachment. Corona discharge treatment is the preferred means of affixing the first outer film member 30 to the outer surface 34 of the first tube wall 14. Corona discharge treatment, or corona treatment, is the process of subjecting the surface of thermoplastic materials, such as polyolefins, to a corona discharge, i.e., the ionization initiated by a high voltage passed through a nearby electrode, and causing oxidation and other changes to the thermoplastic film surface, such as surface roughness and surface tension. Corona treatment of polymeric materials is disclosed in U.S. Pat. No. 4,120,716, to Bonet, issued Oct. 17, 1978, which is incorporated herein in its entirety. Both an outer surface 34 and a tube wall contact surface 32 of the first outer film member 30 are corona treated to preferably increase the surface tension of each treated surface, as measure by wetting tension, to at least 38 dynes/cm and more preferably to about 44 to 46 dynes/cm. The outer film member contact surface 32 may have a higher surface tension if required. In the embodiment shown in FIGS. 1-3, the first outer film member 30 includes first and second lateral portions 36 and 38 that respectively extend in the transverse direction beyond the first and second tube edges 18 and 20 and has a contact surface 32 and opposing exterior surface 33. A second outer film member 40 is affixed by a contact surface 42 to an outer surface 44 of the second tube wall 16. The second outer film member 40 is preferably affixed using the same method as used for the fixation of the first outer film member 30, however, a different method may be used. The second outer film member 40 includes third and fourth lateral portions 46 and 48 that respectively extend in the transverse direction beyond the first and second tube edges 18 and 20 and has a contact surface 42 and opposing exterior surface 43. Preferably, the first, second, third and fourth lateral portions 36, 38, 46 and 48 extend a substantially equal amount past the first and second tube edges 18 and 20, where the first and second outer film members are affixed to each other. In other words, the first and third lateral portions 36 and 46 extend beyond the first tube edge 18 and preferably bond to each other by any suitable means such as the bonding processes described above, and preferably by a non-heat fusion method. Likewise, the second and fourth lateral portions 38 and 48 extend beyond the second tube edge 20 and bond to one another. Thus, in this preferred embodiment, the first and second outer film members 30 and 40 cover the entire outer surfaces 34 and 44 of the first and second tube walls 14 and 16. In this preferred embodiment, the full coverage of the tube member 12 ensures that the bag will never have an occurrence of an “uncovered” puncture, which is a problem with patch bags. As previously discussed, patch bags do not provide 100% coverage of the inner bag film, or tube member, which results in increased failure rates due to “uncovered” punctures e.g. in uncovered side, bottom or neck areas.

The bag 10, in its completed form, includes a lateral seal 50, which extends laterally across at least the width of the tube member 12, at least from edge 18 to opposing edge 20, and preferably across the entire width of the bag 10 from bag edge 52 to opposing bag edge 54. Provision of the lateral seal 50 across at least the width of tube member 12 of bag 10 forms an end-seal bag. A suitable lateral seal 50 is made through the first and second tube walls 14 and 16 and the first and second outer film members 30 and 40. Generally, the lateral seal 50 is accomplished by supplying sufficient heat and pressure to the adjacent film surfaces for sufficient time to cause a fusion bond between the layers. Alternatively, any method may be used which creates a hermetic seal 50 and it is sufficient that such hermetic seal bonds interior surface 56 of tube wall 14 to interior surface 58 of opposing tube wall 16 to form a strong airtight seal 50. It is not necessary that either or both of the first and second tube walls 14 and 16 be fusion bonded to the first and second outer film members 30 and 40. A common type of seal used in the manufacturing of bags is known to those skilled in the art as a hot bar seal. In making a hot bar seal, adjacent layers of film are held together by opposing bars of which at least one is heated to cause the adjacent thermoplastic layers to fusion bond by application of the heat and pressure across the area to be sealed. Impulse seals, known to those in the art may also be used. The configuration of the lateral seal 50 may be of any shape suitable for the product to be packaged. Common seal shapes include: straight seals which usually extend perpendicular to tube edges 18 and 20 (the tube edges 18 and 20 typically extend parallel to each other), and also include nonlinear or curved edges e.g. such as those described in U.S. Pat. No. 5,149,943, which patent is hereby incorporated by reference in its entirety. Both linear or non linear seals may be made by any suitable method known in the art including hot bar or impulse seals.

Another preferred embodiment is shown in FIGS. 5 and 6. FIG. 5 is a side view of a bag indicated generally as 110. Bag 110 includes a lay-flat member 112 formed by flattening or collapsing a tubular film similar to the lay-flat tube member 12 shown in FIGS. 1-3. The lay-flat tube member 112 includes a first tube wall 114, an opposed second tube wall 116, a first tube edge 118, an opposed second tube edge 120, a first tube end 115, an opposed second tube end 117, a product receiving chamber 122 and a mouth 124 similar to bag 10 discussed above. Bag 110 includes a first outer film member 130 affixed at interior surface 132 to an outer surface 134 of the first tube wall 114 using similar methods as discussed with respect to bag 10. The outer film member 130 extends the entire length of the bag 110, however, the first outer film member 130 has a width less than the width of the first tube wall 114. The width of the first outer film member 130 may vary depending on the amount of coverage that is required. Further, while the first outer film member is shown substantially centered between the first and second tube edges 118 and 120, such centering of the outer protective film is not necessary. By varying the width of the outer film members, a bag may be provided for a specific cut of meat wherein the puncture-resistance is in an area where protruding bones are typically aligned. For example, a specific bone-in cut of meat may typically have a bone protrusion that is always positioned such that puncture protection is only required within the center 50% of the bag. This allows the bag manufacturer to reduce the amount of puncture-resistant materials consumed and thereby provide a cost efficient bag for a specific cut of meat, while also providing continuous protection from mouth to bottom.

A second outer film 140 is affixed at interior surface 142 to an outer surface 144 of the second tube wall 116. The second outer film member 140 has a length equal to the second tube wall 116, but the second outer film member 140 does not extend the full width of the second tube wall 116. The width of both the first and second outer film members 130 and 140 may vary, while the length equals that of the lay-flat tube member 112. Optionally, one of the outer film members 130 and 140 may have a width less than, equal to or exceeding the width of the lay-flat tube member 112, while the other outer film member independently has a width less than, equal to or exceeding the lay-flat tube member 112.

A lateral seal 150 extends across the width of the lay-flat tube member 112. The lateral seal 150 is provided through the first and second tube walls 14 and 16 and the first and second outer film members 30 and 40. Generally, the lateral seal 150 is accomplished by supplying sufficient heat and pressure to the adjacent film surfaces for sufficient time to cause a fusion bond between the layers, using similar methods as disclosed for the lateral seal 50 of bag 10.

The films that form the tube member, or “bag film”, and the outer film members, or “puncture-resistant” or abrasion-resistant layers, may be multilayer or monolayer thermoplastic polymeric flexible films. Preferred films are heat-shrinkable. Preferred films may also provide a beneficial combination of one or more or all of the below noted properties including high puncture resistance(e.g. as measured by the ram and/or hot water puncture tests), high shrinkage values, low haze, high gloss, and high seal strengths. Preferably both the bag film and outer film members are heat-shrinkable and advantageously may have an unrestrained shrinkage of at least 20% in each direction and most preferably 40% or more in both the machine and transverse directions. Free shrink is measured by cutting a square piece of film measuring 10 cm in each of the machine and transverse directions. The film is immersed in water at 90° C. for five seconds. After removal from the water the piece is measured and the difference from the original dimension is multiplied by ten to obtain the percentage of shrink. Although heat-shrinkable films are preferred, non-heat-shrinkable films or foils or combinations of heat shrinkable and non-heat shrinkable films or foils may be used with the bag structures and methods disclosed herein.

Although the films used in the failure-resistant bag according to the present invention can be monolayer or multilayer films, the lay-flat tube member is preferably formed of a multilayer film having 2 or more layers; more preferably 3 to 9 layers; and still more preferably 3 to 5 to 7 layers. Since the inventive bags are primarily intended to hold bone-in food products after evacuation and sealing, it is preferred to use a thermoplastic film for the seamless tube member's construction which includes an oxygen and/or moisture barrier layer. The terms “barrier” or “barrier layer” as used herein means a layer of a multilayer film which acts as a physical barrier to moisture or oxygen molecules. Advantageous for packaging of oxygen sensitive materials such as fresh red meat, a barrier layer material in conjunction with the other film layers will provide an oxygen gas transmission rate(O₂GTR) of less than 70 (preferably 45 or less, more preferably 15 or less ) cc per square meter in 24 hours at one atmosphere at a temperature of 73° F. (23° C.) and 0% relative humidity. A preferred multilayer barrier film structure for use with the present invention is shown in FIG. 7. When an oxygen barrier layer 60 is needed, it is usually provided as a separate layer of a multilayer film 80, most commonly as the core layer sandwiched between an inner heat sealing layer 62 and an outer layer 64, though additional layers may also be included, such as tie or adhesive layers as well as layers to add or modify various properties of the desired film, e.g., heat sealability, toughness, abrasion resistance, tear-resistance, heat shrinkability, delamination resistance, stiffness, moisture resistance, optical properties, printability, etc. Oxygen barrier materials which may be included in the films utilized for the inventive bags include ethylene vinyl alcohol copolymers (EVOH), metal foils, metallized polyesters, polyacrylonitriles, silica oxide treated polymeric films, polyamides and vinylidene chloride copolymers (PVDC). Preferred oxygen barrier polymers for use with the present invention are vinylidene chloride copolymers or vinylidene chloride with various comonomers such as vinyl chloride (VC-VDC copolymer) or methyl acrylate (MAVDC copolymer), as well as EVOH. A specifically preferred barrier layer comprises about 85% vinylidene chloride-methyl acrylate comonomer and about 15% vinylidene chloride-vinyl chloride comonomer, as for example described in Schuetz et al. U.S. Pat. No. 4,798,751. Suitable and preferred EVOH copolymers are described in U.S. Pat. No. 5,759,648. The teachings of both the '751 and '648 patents are hereby incorporated by reference in their entireties.

The inner heat sealing layer 62 is generally provided on a side of the barrier layer 60 that becomes the inner tubular surface 66 of the puncture-resistant bag. Other film layers may optionally be incorporated between the barrier layer and the inner heat sealing layer as previously noted. Substantially linear copolymers of ethylene and at least one alpha-olefin as well as copolymers of ethylene and vinyl esters or alkyl acrylates, such as vinyl acetate, may be usefully employed in one or more layers of the tube member and/or film members, and may comprise monolayer and multilayer thermoplastic films. Preferably, the inner heat sealing layer comprises a blend of at least one ethylene-α-olefin copolymer (EAO), with ethylene vinyl acetate (EAO:EVA blend). Suitable (α-olefins include C₃ to C₁₀ alpha-olefins such as propene, butene-1, pentene-1, hexene-1, methylpentene-1, octene-1, decene-1 and combinations thereof. The heat seal layer is optionally the thickest layer of a multilayer film and may significantly contribute to the puncture resistance of the film. Another desirable characteristic affected by this layer is the heat seal temperature range. It is preferred that the temperature range for heat sealing the film be as broad as possible. This allows greater variation in the operation of the heat sealing equipment relative to a film having a very narrow range. For example, it is desirable for a suitable film to heat seal over a broad temperature range providing a heat sealing window of 80° F. or higher.

The outer layer 64 is provided on the side of the barrier layer opposite the heat sealing layer 62 and acts as the outer surface of the lay-flat tube member to which the outer film members 68 are affixed. Other polymer layers may optionally be provided between the barrier layer and the outer layer as previously discussed. The outer layer may comprise an ethylene-α-olefin copolymer (EAO), ethylene vinyl acetate copolymer (EVA) or blends thereof. EAOs are copolymers predominately comprising ethylene polymeric units copolymerized with less than 50% by weight of one or more suitable α-olefins which include C₃ to C₁₀ alpha-olefins such as propene, butene-1, pentene-1, hexene-1, methylpentene-1, octene-1, decene-1. Preferred alpha-olefins are hexene-1 and octene-1. Recent developments for improving properties of a heat-shrinkable film include U.S. Pat. No. 5,403,668, incorporated herein, which discloses a multilayer heat-shrinkable oxygen barrier film wherein the film outer layer is a four component blend of VLDPE, LLDPE, EVA and plastomer. LLDPE, or linear low density polyethylene, is a class of ethylene-alpha olefin copolymers having a density greater than 0.915 g/cm³. VLDPE, also called ultra low density polyethylene (ULDPE), is a class of ethylene-alpha olefin copolymers having a density less than 0.915 g/cm³ and many commercial VLDPE resins are available having densities from 0.900 up to 0.915 g/cm³. Plastomers are generally EAOs having densities below 0.900 g/cm³. U.S. Pat. No. 5,397,640 discloses a multilayer oxygen barrier film wherein at least one outer film layer is a three component blend of VLDPE, EVA and a plastomer. Alternatively, the outer layer may be formed of other thermoplastic materials as for example polyamide, styrenic copolymers, e.g., styrene-butadiene copolymer, polypropylene, ethylene-propylene copolymer, ionomer, or an alpha olefin polymer and in particular a member of the polyethylene family such as linear low density polyethylene (LLDPE), very low density polyethylene (VLDPE and ULDPE), high density polyethylene (HDPE), low density polyethylene (LDPE), an ethylene vinyl ester copolymer or an ethylene alkyl acrylate copolymer or various blends of two or more of these materials.

The outer film members are preferably selected from the group of puncture-resistant films, and are preferably monolayer films, although a multilayer puncture-resistant film is contemplated by the present invention. The puncture-resistant and abrasion-resistant films for use as the outer film members may be any film that provides the bag with the desired puncture-resistance or abrasion-resistance. Preferably, the outer film members are monolayer, biaxially oriented shrink films as previously discussed. The first and second outer film members may include films of the same or similar composition, but this is not required. Preferred puncture-resistant films comprise a blend of at least one linear ethylene-α-olefin copolymer and an ionomer, e.g., an ethylene-methacrylate acid copolymer whose acid groups have been neutralized partly or completely to form a salt, preferably a zinc or sodium salt. Alternatively, the outer film member may be formed of other thermoplastic materials as for example polyamide, styrenic copolymers, e.g., styrene-butadiene copolymer, polypropylene, ethylene-propylene copolymer, ionomer, or an ethylene olefin polymer and in particular a member of the polyethylene family such as LLDPE, VLDPE, ULDPE, HDPE, LDPE, an ethylene vinyl ester copolymer or an ethylene alkyl acrylate copolymer or various blends of two or more of these materials. The outer film members may also comprise metal foils or metallized plastic films.

In general, the monolayer or multilayer films used in the puncture-resistant bags of the present invention can have any thickness desired, so long as the films have sufficient thickness and composition to provide the desired properties for the particular packaging operation in which the film is used, e.g., puncture-resistance, modulus, seal strength, barrier, optics, etc. For efficiency and conservation of materials, it is desirable to provide the necessary puncture-resistance and other properties using the minimum film thicknesses. Preferably, the tube member bag film has a total thickness from about 1.5 to about 4.0 mils; more preferably from about 2.0 to about 3.0 mils. The outer film member film preferably has a thickness from about 2.0 to about 6.0 mils; more preferably about 3.5 to about 4.5 mils. Preferably bags and rollstock laminates of the present invention will have a total thickness of the combined first and second tube wall of the tube member and any affixed outer film members of at least 5.0 mil, and preferably up to about 16.0 mil, and more preferably will be at least 6.0 mil up to 14.0 mil in total thickness.

Suitable films for use with the present invention are disclosed in U.S. Pat. No. 5,928,740, incorporated herein by reference thereto in its entirety. The '740 patent discloses a heat sealing layer comprising a blend of a first polymer of ethylene and at least one α-olefin having a polymer melting point between 55 to 75° C.; a second polymer of ethylene and at least one α-olefin having a polymer melting point between 85 to 110° C. and a third thermoplastic polymer having a melting point between 115 to 130° C. which is preferably selected from the group of ethylene homopolymers such as HDPE and LDPE, and ethylene copolymers with at least one α-olefin; and optionally and preferably a fourth polymer such as a copolymer of ethylene with an alkyl acrylate or vinyl ester having a melting point between 80 to 105° C., preferably 90 to 100° C. The '740 patent also discloses a preferred biaxially oriented, heat-shrinkable three-layer barrier film embodiment for use as a lay-flat tube member with the present invention. The three-layer barrier film embodiment comprises an inner heat sealing layer as described above in conjunction with a barrier layer preferably comprising a polyvinylidene chloride (PVDC) or vinylidene chloride methylacrylate copolymer (VDC-MA or MA-saran) or EVOH layer and an outer layer formed of at least 50 wt. %, and preferably at least 70%, of a copolymer of ethylene with at least one alpha-olefin or at least one vinyl ester or blends thereof. Also, preferred EVAswill have between about 3% and about 18% vinyl acetate content.

Preferred films for use with the present invention are disclosed in U.S. patent application Ser. No. 09/401,692 filed Sep. 22, 1999, and incorporated herein by reference in its entirety. The '692 application discloses monolayer and multilayer films having at least one layer comprising at least a three-polymer blend, optionally including a fourth polymer, comprising: (a) a first polymer having a melting point of 80 to 98° C., preferably 80-92° C., comprising a copolymer of ethylene and hexene-1; (b) a second polymer having a polymer melting point of 115 to 128° C. comprising ethylene and at least one α-olefin; and (c) a third polymer having a melting point of 60 to 110° C. comprising a copolymer of ethylene with an alkyl acrylate or vinyl ester; and optionally (d) a fourth polymer having a melting point of 80 to 110° C. (preferably of 85 to 105° C.), preferably selected from the group of ethylene homopolymers such as HDPE and LDPE, and ethylene copolymers with at least one α-olefin. The inventive blend finds utility as an inner heat sealing layer in many multilayer embodiments. In a preferred three, four or five-layer embodiment, an oxygen barrier layer of a vinylidene chloride copolymer, a polyamide or EVOH is between a layer of the inventive blend and either a layer comprising at least 50% by weight of an EAO or at least one vinyl ester or blends thereof, or another layer comprising the inventive blend. The '692 inventive blend may also be used in either or both of the present tube member and outer film members.

Additional preferred films for use with the tube member and/or outer film members of the present invention are disclosed in U.S. patent application Ser. No. 09/611,192 filed Jul. 6, 2000, which is incorporated by reference herein in its entirety. The '192 application discloses multi-layer barrier embodiments formed of a flexible, thermoplastic, biaxially stretched, heat-shrinkable film having at least one layer comprising a blend of at least three copolymers comprising: 45 to 85 weight percent of a first polymer having a melting point of from 55 to 98° C. comprising at least one copolymer of ethylene and at least one comonomer selected from the group of hexene-1 and octene-1; 5 to 35 weight percent of a second polymer having a melting point of from 115 to 128° C. comprising at least one copolymer of ethylene and at least one αolefin; and 10 to 50 weight percent of a third polymer having a melting point of from 60 to 110° C. comprising at least one unmodified or anhydride-modified copolymer of ethylene and a vinyl ester, acrylic acid, methacrylic acid, or an alkyl acrylate; where the first and second polymers above have a combined weight percentage of at least 50 weight percent based upon the total weight of the first, second and third polymers; and where the bag film has a total energy absorption of at least 0.70 Joule and a shrinkage value at 90° C. of at least 50% in at least one of the machine and transverse directions. A barrier layer formed of any suitable oxygen barrier material or blend of materials, for example, ethylene-vinyl alcohol copolymer (EVOH) or copolymers of vinylidene chloride (VDC) such as VDC-vinyl chloride (VDC-VC) or VDCmethylacrylate (VDC-MA) may be used. Preferably the barrier layer comprises a blend of 85 wt. % VDC-MA and 15 wt. % VDC-VC. The outer layer is preferably an EVA-VLDPE blend, and more preferably an EVA-VLDPE-plastomer blend. The '192 application also discloses a preferred puncture-resistant film, for use as outer film members, comprising a flexible, thermoplastic film having at least one layer comprising a blend of at least two polymers comprising: 5 to 20 weight percent of (i) an ionomer polymer, e.g., an ethylene-methacrylate acid copolymer whose acid groups have been neutralized partly or completely to forma salt, preferably a zinc or sodium salt; 5 to 95 weight percent of (ii) a copolymer of ethylene and at least one C₆ to C₈ α-olefin, having a melting point of from 55 to 95° C., and a \overline{M}_{w}/\overline{M}ₙ of from 1.5 to 3.5; 0 to 90 weight percent of (iii) a copolymer of ethylene and at least one C₄ to C₈ α-olefin, having a melting point of from 100 to 125° C.; and 0 to 90 weight percent of (iv) a copolymer of propylene and at least one monomer selected from the group of ethylene and butene-1, where the copolymer (iv) has a melting point of from 105 to 145° C.; 0 to 90 weight percent of (v) a copolymer of ethylene and at least one monomer selected from the group of hexene-1, octene-1 and decene-1, where the copolymer (v) has a melting point of from 125 to 135° C.; and polymers (ii), (iii), (iv), and (v) have a combined weight percentage of at least 80 weight percent based upon the total weight of polymers (i), (ii), (iii), (iv), and (v); and wherein the puncture-resistant film has a total energy absorption of at least 1.2 Joule. Optionally, the same blend used for the puncture-resistant film may be used as an inner heat sealing layer for a bag film.

Further preferred films for use with the present invention are described in U.S. Pat. No. 5,302,402 to Dudenhoeffer et al., U.S. Pat. No. 6,171,627 and Lustig et al. U.S. Pat. No. 4,863,769, and the previously discussed U.S. Pat. No. 6,015,235 to Kraimer et al., all of which are incorporated herein in their entireties.

In a preferred embodiment of the present invention, the puncture-resistant bag includes a lay-flat tube member formed of a three-layer film and monolayer outer film members. The lay-flat tube member of the bag is preferably a biaxially oriented multilayer shrink film including a barrier layer disposed between an inner heat sealing layer and an outer layer, as shown in FIG. 7. The barrier layer preferably comprises a blend of about 15% vinylidene chloride-vinyl chloride and about 85% vinylidene chloride-methacrylate such as further described in U.S. Pat. No. 4,798,751. The barrier layer preferably comprises approximately 16.5% of the three-layer film's thickness. The inner heat sealing layer preferably comprises about 57.1% of the films thickness and comprises a blend of about 35wt. % of an ethylene-hexene-1 copolymer such as EXACT™ 9519 (0.895 g/cm³ and 2.2 dg/min Melt Index available from Exxon Chemical Co., Houston, Tex., U.S.A.); about 36.5% of an ethylene-octene-1 copolymer such as ATTANE™ XU 61509.32 (a C₂C₈ (<10 wt. % C₈) VLDPE having a density of about 0.912 g/Cm³ and 0.5 dg/min Melt Index available from Dow Chemical Co., Midland, Mich., U.S.A.); about 26.5% of an ethylene-vinyl acetate (EVA) copolymer such as ESCORENE™ LD 701.ID (an ethylene-vinyl acetate copolymer available from Exxon Chemical Co., Houston, Tex., U.S.A. and reportedly having a density of 0.93 g/cm³, a vinyl acetate content of 10.5 wt. a melt index of about 0.19 dg/min., and a melting point of about 97° C.); about 3% of a slip/processing aid such as Spartech A50050 (1.9% oleamide slip and an fluoroelastomer in a VLDPE carrier resin); and about 2% of a processing stabilizer such as Spartech A32434 (10% DHT4A in VLDPE carrier resin available from Spartech Polycom of Washington, Pa., U.S.A.). The outer layer preferably comprises about 26.4% of the film thickness and comprises about 35 wt. % of an ethylene-hexene-1 copolymer such as EXACT™ 9519; about 35% of a ethylene-octene-1 copolymer such as ATTANE™ XU 61509.32; about 27% of a EVA copolymer such as ESCORENE™ LD 701.ID; and about 3% of a slip/processing aid such as Spartech A50050 (available from Spartech Polycom of Washington, Pa., U.S.A.). The puncture-resistant film used for both the first and second outer film members is a biaxially oriented monolayer film comprising a blend of 45 Wt. % of an ethylene-hexene-1 copolymer such as EXACT™ 9519; about 40% of a ethylene-octene-1 copolymer such as ATTANE™ XU 61509.32; about 12% of an ionomer such as SURLYN™ 1705-1 (a Zn-ethylene-methacrylic acid ionomer containing 15% methacrylic acid and having a 5.5 dg/min melt index and 0.950 g/cm³ available from DuPont Company, Wilmington, Del., U.S.A.); and about 3% processing aid such as Ampacet 501237 (available from Ampacet Corp., Tarrytown, N.Y., U.S.A.).

In another preferred embodiment, the lay-flat tube member of the bag comprises a biaxially oriented three-layer seamless tube of heat-shrinkable film having an inner surface layer of the tube made of a blend of about 17 wt. % ethylene-octene-1 copolymer such as ATTANE™ XU 61509.32; about 18 wt. % EVA such ESCORENE™ LD 701.ID; 58% of an ethylene-hexene-1 copolymer such as EXACT™ 9110; about 2% of a processing stabilizer such as Spartech A32434; and about 5% of a slip/processing aid such as Spartech A50050. The outer surface layer is about 19 wt. % ethylene octene-1 copolymer such as ATTANE™ XU 61509.32; 18% EVA (ESCORENE™ LD 701.ID); 60% of an ethylene-hexene-1 copolymer such as EXACT™ 9110; and 3% processing aid such as A50056. The barrier layer is 85% vinylidene chloride-methyl acrylate and about 15% vinylidene chloride-vinyl chloride. Preferably, the inner layer:barrier layer:outer layer thickness ratio is about 62:9:29. The same puncture-resistant film is used for both the first and second outer film members and comprises about 67 wt. % of a plastomer such as Exact 9523(a C₂C₆ copolymer having a density of 0.995 g/cm³, and 1.2 dg/min. M.I.) or EXACT™ SLX-9110 (a C₂C₆ copolymer having a 16.5% C₆ comonomer content, 88.5° C. melting point, 0.80 Melt Index and a density of 0.898 g/cm³); about 16 wt. % of an ethylene-octene-1 copolymer such as ATTANE™ XU 61509.32; about 14 wt. % of an ionomer such as SURLYN™ 1705-1; and about 3 wt. % of a slip/processing aid (such as 1.4 wt. % oleamide and 3.3 wt. % fluoroelastomer in a VLDPE carrier resin).

The tube member and outer film member which make up the inventive receptacle are preferably biaxially oriented by the well-known trapped bubble or double bubble technique as for example described in Pahlke U.S. Pat. No. 3,456,044. In this technique an extruded primary tube leaving the tubular extrusion die is cooled, collapsed and then preferably oriented by reheating and reinflating to form a secondary bubble. The film is preferably biaxially oriented wherein transverse (TD) orientation is accomplished by inflation to radially expand the heated film. Machine direction (MD) orientation is preferably accomplished with the use of nip rolls rotating at different speeds to pull or draw the film tube in the machine direction. The stretch ratio in the biaxial orientation to form the bag material is preferably sufficient to provide a film with total thickness of between about 1.5 and 3.5 mils. The MD stretch ratio is typically 3-5 and the TD stretch ratio is also typically 3:1-5:1.

Referring now to FIG. 8, a double bubble or trapped bubble process is shown. The polymer blends making up the several layers are coextruded by conveying separate melt streams 211a, 211b, and 211c to the die 230. These polymer melts are joined together and coextruded from annular die 230 as a relatively thick walled multilayered tube 232. The thick walled primary tube 232 leaving the extrusion die is cooled and collapsed by nip rollers 231 and the collapsed primary tube 232 is conveyed by transport rollers 233a and 233b to a reheating zone where tube 232 is then reheated to below the melting point of the layers being oriented and inflated with a trapped fluid, preferably gas, most preferably air, to form a secondary bubble 234 and cooled. The secondary bubble 234 is formed by a fluid trapped between a first pair of nip rollers 236 at one end of the bubble and a second pair of nip rollers 237 at the opposing end of the bubble. The inflation which radially expands the film provides transverse direction (TD) orientation. Orientation in the machine direction (MD) is accomplished by adjusting the relative speed and/or size of nip rollers 236 and nip rollers 237 to stretch (draw) the film in the machine direction. Rollers 237 also collapse the bubble forming an oriented film 238 in a lay-flat condition which may be wound on a reel 239 or slit for further processing.

In the case of a multilayer lay-flat tube film, the biaxial orientation preferably is sufficient to provide a multilayer film with a total thickness of from about 1.5 to 4 mils or more, preferably between 2.0 and 3.0 mils (51 to 76 μl), and more preferably about 2.5 mils.

A preferred film and process for making film suitable for tube member and outer film member stock is described in U.S. patent application Ser. No. 09/401,692 filed Sep. 22, 1999 for “Puncture Resistant Polymeric Films, Blends and Process”; U.S. patent application Ser. No. 09/431,931 filed Nov. 1, 1999 for “Puncture Resistant High Shrink Film, Blend and Process”; and U.S. patent application Ser. No. 09/611,192 filed Jul. 6, 2000 for “Ionomeric, Puncture Resistant Thermoplastic Patch Bag, Film, Blend and Process”, the teachings of all of which are hereby incorporated by reference herein.

For a monolayer puncture-resistant film, the process is similar but utilizes a single extruder (or multiple extruders running the same polymeric formulation) to produce a primary tube, and biaxial orientation is sufficient to provide a monolayer film preferably having a total thickness of between 2 to 6 mil or higher, and more typically from about 3.5 to 4.5 mils and is generally in the same draw ratio range as the bag film, namely about 3:1 to 5:1 for both the MD and TD.

After orientation, the tubular lay-flat tube film 238 is collapsed preferably to a flatwidth of about 6 inches to about 48 inches and wound on a reel 239. One skilled in the art will appreciate that the above method may be used to form either or both a seamless tube member and the outer film members. Also unoriented non-heat shrinkable films of seamless tubes may be made by conventional single bubble, blown film processes, and oriented or nonoriented sheets may be made by slot cast sheet extrusion processes with or without tentering to provide orientation. One skilled in the art will further appreciate that the flatwidth of the collapsed tube member will determine the width of the bags that result therefrom. Thus, the primary tube dimensions and subsequent processing may be selected to provide a desired flatwidth and film thickness for the desired application. Tubular outer film members of puncture-resistant film may be slit longitudinally, laid flat and wound on a reel after orientation or alternatively may be formulated to produce a thicker film by collapsing the bubble in a self welding fashion by methods well known in the art.

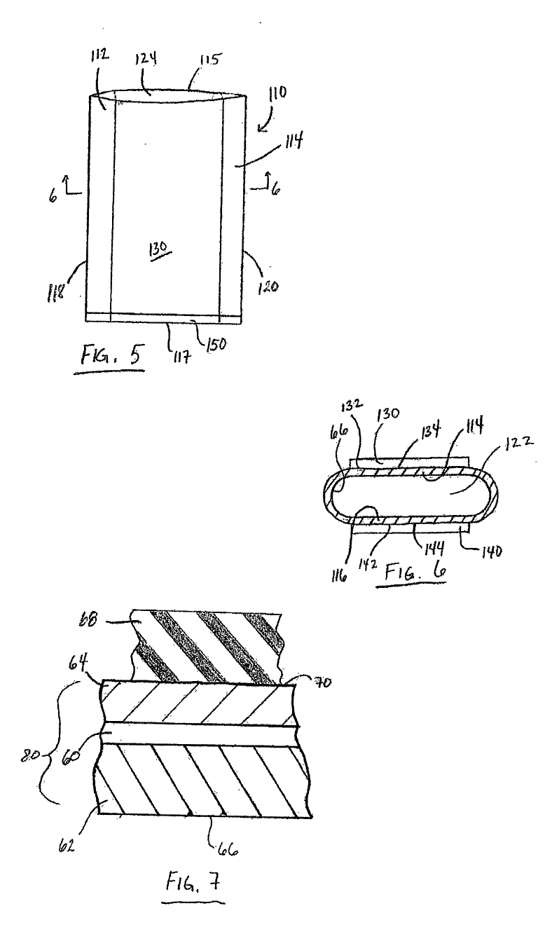

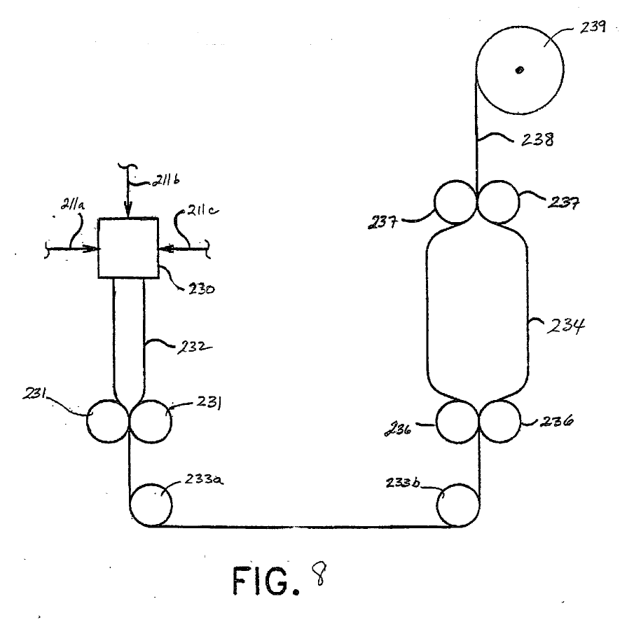

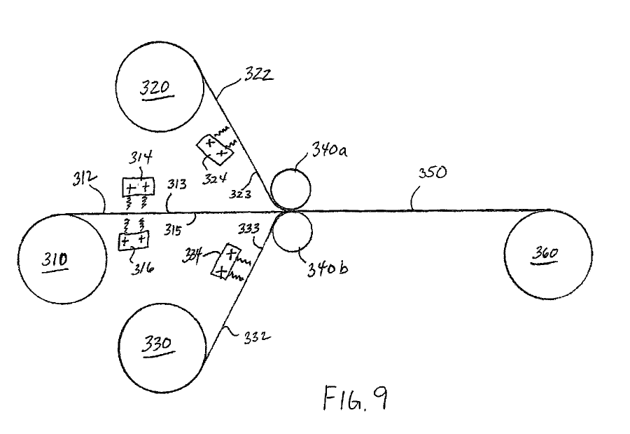

Referring now to FIG. 9, there is shown a simplified schematic of a preferred method of forming a puncture-resistant bag tube stock by affixing first and second outer film members to a tube member. FIG. 4 shows a related perspective view which is also illustrative of the method of making the rollstock composite structure used to make the patchless bag 10 of exemplified in FIGS. 1, 2 and 3. Preferably, the first and second outer film members 322, 332 comprise the same puncture-resistant film and are affixed to the bag film, or lay-flat tube member 312 serially or preferably substantially simultaneously. Tube member film roll 310 supplies flattened tube member 312, which is corona treated on both sides of the flattened tube e.g. by being passed between surface treaters 314 and 316, thereby exposing the surfaces thereof to high energy to increase the surface tension of lay-flat surface 313 and opposing lay-flat surface 315. First outer film roll 320 supplies first outer film member 322 of a puncture-resistant film, which is treated by surface treater 324 to increase the surface tension of a surface 323 thereof. Likewise, second outer film roll 330 supplies second outer film member 332 of puncture-resistant film , which passes by surface treater 334 to increase the surface tension of a surface 333 thereof. The aforementioned surface treatments are preferably accomplished by corona discharge, although other methods such as flame, and plasma, may be used as well as adhesives such as isocyanate based adhesives, or polymeric melts (although such melts should not be used with films under conditions which may cause undesirable heat distortion of e.g. heat shrinkable films. Also, as previously stated, any method known in the art to bond together two or more layers of film or other material may be used. Advantageously, the bond interface should have sufficient physical strength to withstand the tension resulting from stretching or shrinking around the item sealed within the bag. The surface treatments should increase the surface tension of each treated surface, as measured by wetting tension, to at least about 38 dynes/cm and preferably to about 44 to 46 dynes/cm. Advantageously, the puncture-resistant outer film members may have a higher surface tension.

After the surface energies of the flattened bag film 312 and first and second puncture-resistant films 322 and 332 have been raised, the three film structures are passed between pinch rolls 340a and 340b such that the flattened tube 312 is disposed between the first and second puncture-resistant films 322 and 332. The pinch rolls 340a and 340b serve to press together the four treated surfaces such that first outer film member treated surface 323 contacts and securely attaches to a first corona treated surface 313 of tube member 312 and second outer film member treated surface 333 contacts and securely attaches to a second corona treated surface 315 of tube member 312 thereby causing the first outer film member 322, tube member 312 and second outer film member 332 to bond or attach in a generally secure manner and form a puncture resistant composite structure comprising a bag tube stock 350. By “securely attaches” is meant that the film member and tube member are connected together in a manner sufficient to permit further processing and machining to form bags without unintended separation or displacement. The composite structure 350 is then wound on composite roll 360 as puncture-resistant bag tube stock or directed to a bag making assembly (not shown). Alternatively, the first and second puncture-resistant polymeric films (or metal foils) 322 and 332 may be affixed in a two-step process wherein the first puncture-resistant film (or foil) 322 is affixed to the flattened (polymeric film or foil)tube member and the intermediate composite structure is taken up on a reel. The intermediate composite structure reel is then returned to the start of the process and is unwound and passed through the same process to affix the second puncture-resistant film 332.

The intermediate composite having on outer film or metal foil attached on one side only of the tube member may be used to produce bags without further application of an opposing second outer film. Such one-sided laminate bags may be commercially useful, but bags having a film or foil member attached on both sides are preferred with complete coverage of the entire exterior of the tube member to provide a thick patchless bag being especially preferred.

The composite structure comprising a bag tube stock of a seamless tube member having first and second outer members affixed (securely attached) to opposing sides of said tube member may be provided wound on cores as rollstock (reels of wound tube stock). Such rollstock may be utilized by a bag maker to create end sealed bags for resale to food or meat packers or other product packagers. Alternatively such rollstock may be provided to end users having suitable equipment to enable manufacture of bags according to a set adjustable bag length or to customized bag lengths according to the dimensions of individual articles such as cuts of meat. Advantageously, the present invention may be used by a packager as rollstock, as a shirred tube or otherwise provided as a continuous tube having lengths of up to, including, and in excess of 10-20 meters.

Advantageously, a bag maker or end user packager may produce bags of various lengths from rolls of bag tube stock by adjusting the distances between the transverse end seal and bag mouth for a particular bag or series of bags. This avoids the costly need to stock various sizes of patches for intermittently placed patch bags which are currently widely used by meat packers. Also the present invention permits cost savings and manufacturing efficiencies by permitting creation of standardized widths of bag tube rollstock which may be made into bags of varying lengths for each set width depending on customer demand. This reduces the need to carry larger inventories of a vast array of bags having differently sized and placed patches which are dependent upon the length of the bag desired. Instead a roll of bag tube stock comprising a tube member having one or more attached outer film members may be stocked for use in making bags of any desired length because the transverse seal and/or cuts are not required to be made through patchless areas or sides. For the first time bags of adjustable lengths may be made by transversely sealing and cutting through a combined bag thickness across a seamless tube member having film members covering opposing sides of the tube for a bag having a thickness (from an exterior to enclosed product contact side) of up to 3.0 to 3.5 to 5 to 6 to 7 mils or more, and for a combined collapsed lay-flat bag thickness from exterior side to opposing exterior side of 6 to 7 to 10 to 12 to 14 mils or higher. Prior to the invention such bag stock did not exist.

Another advantage of the present invention is that the prior art patch bag technology required use of higher modulus materials to provide the stiffness needed for accurate patch placement. Stiff materials were needed to avoid undesirable folds as well as alignment and misplacement problems associated with handling more flexible materials. Beneficially outer film members, especially biaxially oriented or heat shrinkable members, having an elongation at break of >200% or >250% or >300% and/or a 1% secant modulus value of <20,000 psi or <17,500 psi or <15,000 psi in at least one or optionally both directions (MD and TD) may be used without suffering from the above problems which are virtually eliminated by the present invention. The present invention may continuously apply one or more outer film members which extend over the entire length and optionally width of the seamless tube and there are no leading or trailing edges of a patch to be intermittently placed. Thus, there is a reduction in waste especially at start up in the inventive patchless manufacturing process relative to the waste created in the prior art processes by folded or misplaced patches. In one embodiment of the invention the first outer film member and the second outer film member comprise a continuous film of at least one layer and the continuous film may be wrapped around at least one edge of said first and said second tube walls. This continuous film may be an integral single or multiply sheet or film.

For bag making the composite film structure 350 is directed to a bag making assembly (not shown) where individual end-seal bags are made. End-seal bags are produced by making lateral, or transverse, heat seals across the composite structure 350 width at spaced intervals to weld the first and second tube walls of the lay-flat tube member together. The composite structure 350 is severed preferably at the same time or during the same step that it is heat sealed to form a bag as shown in FIG. 1. Typically as the end seal is made for one bag a transverse cut forming the mouth of the adjacent bag is being made. This process forms a so called “end-seal” bag which, when it is laid flat, has a bottom edge formed by the heat seal, an open mouth formed by the severed edge and two seamless interior side edges formed by the fold produced when the tube is laid flat. The lateral heat seal should extend at least across the entire flattened tube (or lay-flat tube member), since the width of the first and second puncture-resistant films 322 and 332 may be less than the width of the flattened bag film. Each bag being formed from a length of tube will necessarily be formed by at least two, usually parallel, spaced apart, transverse cuts which cause a segment of the tube to be made and one transverse seal , usually adjacent one of these cuts, will define a bag end seal which is located opposing the bag mouth which is formed by the distal cut. In typical production the tube is sealed and an adjacent transverse cut made as part of the same step and the seal and this proximate cut form a sealed end for one bag while the same cut also forms the mouth opening for the adjacent bag, and for that adjacent bag may be referred to as the distal cut. The spacing between the lateral seal and the point of severance, which may vary, will determine the length of the bags formed. The length of the bags can easily be varied by changing the distance between cuts. The width of the bags can also be easily varied by changing the dimensions of the lay-flat tube member and, correspondingly, the width of the first and second outer film members. In another embodiment of the invention, cuts and seals may be made alternately and apart from each other to for dual attached bags in saddle bag fashion. In yet another embodiment of the invention the seamless tube member may be transversely sealed with a plurality of spaced apart hermetic seals extending from a first tube edge to an opposing second tube edge and subsequently one or more layers of a first and/or second outer film member affixed to either or both sides of the pre-sealed tube member. Bags may then be form by register cutting across the tube transversely to form a bag mouth and separate the bags.

The present invention advantageously provides for producing a puncture-resistant bag wherein the bag manufacturer may produce multiple bag sizes (different lengths) from a single puncture-resistant bag tube stock size with out the need to manufacture different sized patches. In other words, the present invention allows the bag manufacturer to produce several standard widths of puncture-resistant bag tube stock, such as 8 inch, 12 inch and 16 inch. These standard composite structures may then be sealed and cut to form any desired length for that width of tube, such as 16×32 inch, 16×40 inch or 16×42 inch without the necessity of manufacturing, positioning and applying different patch sizes. Prior art patch bags require the manufacturer thereof to produce different patch sizes for each size of patch bag produced and expensive equipment is required to accurately apply the individual patches. The bags made according to the present invention advantageously include continuous puncture protection from the mouth of the bag (where the final lateral seal is placed after product insertion) through the bottom seal, and on both sides of the bag. Preferably, the bags according to the present invention have 100% coverage of the lay-flat tube member, so as to increase the puncture-resistance of the bag and to eliminate any portions of the bag that are more susceptible to puncture than others.

Unless otherwise noted, the following physical properties are used to describe the invention, films and seals. These properties are measured by either the test procedures described below or tests similar to the following methods.

Average Gauge: ASTM D-2103

Tensile Strength: ASTM D-882, method A

1% Secant Modulus: ASTM D-882, method A

Oxygen Gas Transmission Rate (O₂GTR): ASTM D-3985-81

Percent Elongation at Break: ASTM D-882, method A

Molecular Weight Distribution: Gel permeation chromatography

Gloss: ASTM D-2457, 45° Angle

Haze: ASTM D-1003-52

Melt Index: ASTM D-1238, Condition E (190° C.) (except for propene-based (>50% C₃ content) polymers tested at Condition L(230° C.))

Melting Point: ASTM D-3418, peak m.p. determined by DSC with a 10° C./min. heating rate.

Vicat Softening Point (Vsp): ASTM D-1525-82

All ASTM test methods noted herein are incorporated by reference into this disclosure.

Shrinkage Values:

Shrinkage values are obtained by measuring unrestrained shrink of a 10 cm. square sample immersed in water at 90° C. (or the indicated temperature if different) for ten seconds. Four test specimens are cut from a given sample of the film to be tested. Specimens are cut into squares of 10 cm length (M.D.) by 10 cm. length (T.D.). Each specimen is completely immersed for 10 seconds in a 90° C. (or the indicated temperature if different) water bath. The specimen is then removed from the bath and the distance between the ends of the shrunken specimen is measured for both the M.D. and T.D. directions. The difference in the measured distance for the shrunken specimen and each original 10 cm. side is multiplied by ten to obtain percent shrinkage in each direction. The shrinkage of 4 specimens is averaged and the average M.D. and T.D. shrinkage values reported. The term “heat shrinkable film at 90° C.” means a film having an unrestrained shrinkage value of at least 10% in at least one direction.

Tensile Seal Strength (Seal Strength) Test

Five identical samples of film are cut 1 inch (2.54 cm) wide and a suitable length for the test equipment e.g. about 5 inches (77 cm) long with a 1 inch (2.54 cm) wide seal portion centrally and transversely disposed. Opposing end portions of a film sample are secured in opposing clamps in a universal tensile testing instrument. The film is secured in a taut snug fit between the clamps without stretching prior to beginning the test. The test is conducted at an ambient or room temperature (RT) (about 23° C.) test temperature. The instrument is activated to pull the film via the clamps transverse to the seal at a uniform rate of 12.0 inches (30.48 cm) per minute until failure of the film (breakage of film or seal, or delamination and loss of film integrity). The test temperature noted and lbs. force at break are measured and recorded. The test is repeated for four additional samples and the average grams at break reported.

Ram Puncture Test

The ram puncture test is used to determine the maximum puncture load or force, and the maximum puncture stress of a flexible film when struck by a hemispherically or spherically shaped striker. This test provides a quantitative measure of the puncture resistance of thin plastic films. This test is further described in U.S. patent application Ser. No. 09/401,692.

Following are examples and comparative examples given to illustrate the invention.

In all the following examples, unless otherwise indicated, the film compositions were produced generally utilizing the apparatus and method described in U.S. Pat. No. 3,456,044 (Pahlke) which describes a coextrusion type of double bubble method and in further accordance with the detailed description above. In the following examples, all layers were extruded (coextruded in the multilayer examples) as a primary tube which was cooled upon exiting the die e.g. by spraying with tap water. This primary tube was then reheated by radiant heaters(although means such as conduction or convection heating may be used) with further heating to the draw (orientation) temperature for biaxial orientation accomplished by an air cushion which was itself heated by transverse flow through a heated porous tube concentrically positioned around the moving primary tube. Cooling was accomplished by means of a concentric air ring. Draw point temperature, bubble heating and cooling rates and orientation ratios were generally adjusted to maximize bubble stability and throughput for the desired amount of stretching or orientation. All percentages are by weight unless indicated otherwise.

### EXAMPLE

A puncture-resistant bag according to the present invention, as generally illustrated in FIGS. 1 & 7, was produced that included a tube member, or bag film, comprising a coextruded three-layer biaxially oriented shrink film having (A) an inner heat sealing layer, (B) a barrier layer and (C) an outer layer. The inner and outer layers being directly attached to opposing sides of the barrier layer. The three layers included the following compositions:

(A) 35 wt. % EXACT™ 9519; 36.5% ATTANE™ XU 61509.32; 26.5% ESCORENE™ LD 701.ID; 3% Spartech A50050; and 2% Spartech A32434;

(B) a blend of about 85% vinylidene chloride-vinyl chloride copolymer and about 15% vinylidene chloride-methacrylate copolymer; and

(C) 35 wt. % EXACT™ 9519; 35% ATTANE™ XU 61509.32; 27% ESCORENE™ LD 701.ID; and 3% Spartech A50050.

One extruder was used for each layer. Each extruder was connected to an annular coextrusion die from which heat plastified resins were coextruded forming a primary tube. The resin mixture for each layer was fed from a hopper into an attached single screw extruder where the mixture was heat plastified and extruded through a three-layer coextrusion die into the primary tube. The extruder barrel temperature for the barrier layer (B) was between about 250-300° F. (121-149° C.); for the inner layer (A) and for the outer layer (C) were about 290-330° F.(143-165° C.). The coextrusion die temperature profile was set from about 320 to 350° F. (163 to 177° C.). The extruded multilayer primary tube was cooled by spraying with cold tap water 50-68° F. (about 10-20° C.).

A cooled primary tube of about 45 to 165 mm flatwidth was produced passing through a pair of nip rollers. The cooled flattened primary tube was inflated, reheated, biaxially stretched, and cooled again to produce a biaxially stretched and biaxially oriented film which was wound on a reel. The M.D. orientation ratio was about 5:1 and the T.D. orientation ratio was about 4:1. The draw point or orientation temperature was below the predominant melting point for each layer oriented and above that layer's predominant glass transition point and is believed to be about 68-85° C. The resultant biaxially oriented bag film had an average gauge of about 2.5 mil and had an excellent appearance.

Both outer film members used the identically formulated and processed puncture-resistant film. The puncture-resistant outer film member was a monolayer, biaxially stretched film made according to the above-described orientation process. The monolayer puncture-resistant film formulation comprised: 45 Wt. % EXACT™ 9519; 40% ATTANE™ XU 61509.32; 12% SURLYN™ 1705-1; and 3% Ampacet 501237. The monolayer puncture-resistant film formulation was blended and fed from a hopper into an attached single screw extruder extruded through an annular die from which the heat plastified resin blend formed a primary tube. The extruder barrel temperature was between about 290-330° F. (143-165° C.). The die temperature was set from about 320 to 350° F. (163 to 177° C.). The extruded primary tube was cooled by spraying with cold tap water 50-68° F. (about 10-20° C.).

A cooled monolayer primary tube of about 45 to 165 mm flatwidth was produced passing through a pair of nip rollers. The cooled flattened primary tube was inflated, reheated, biaxially stretched, and cooled again to produce a biaxially stretched and biaxially oriented tubular film which was wound on a reel. The machine direction (MD) orientation ratio was about 4.5:1 and the transverse direction (TD) orientation ratio was about 4:1 the film. The draw point or orientation temperature was below the predominant melting point for each layer oriented and above that layer's predominant glass transition point and is believed to be about 68-85° C. The resultant biaxially oriented puncture-resistant film had an average gauge of about 4 mil and had an excellent appearance. The tubular puncture-resistant film was slit to form sheets having widths of approximately 175-660 mm and wound on reels.

Although not essential, it is preferred to irradiate the entire bag film to broaden the heat sealing range and/or enhance the toughness properties of the inner and outer layers by irradiation induced cross-linking and/or scission. This is preferably done by irradiation with an election beam at dosage level of at least about 2 megarads (MR) and preferably in the range of 3-5 MR, although higher dosages may be employed especially for thicker films or where the primary tube is irradiated. Irradiation may be done on the primary tube or after biaxial orientation. The latter, called post-irradiation, is preferred and described in Lustig et al. U.S. Pat. No. 4,737,391, which is hereby incorporated by reference. An advantage of post-irradiation is that a relatively thin film is treated instead of the relatively thick primary tube, thereby reducing the power requirement for a given treatment level.

The tubular film was unwound and both outer surfaces were corona treated. Similarly, the puncture-resistant films were unwound and a surface of each was corona treated. The three films were then pressed together, as discussed above to ensure contact of each treated surface with another treated surface, thereby bonding the three films into a continuous three-film composite structure having a monolayer film member securely attached to each side of the lay-flat tube member. Bags similar to the bag 10 depicted in FIG. 1 were formed by sealing laterally across the three-film composite structure and simultaneously severing the sealed portion from the continuous three-film composite structure.

Various tests were performed on the resultant inventive bags. The gauge thickness was measured from the exterior through the outer film member and tube member an a bag thickness was determined to be an average 6.9 mil with the transverse end seal being made through a total thickness that is calculated to be on average 13.8 mil in thickness. This same seal was tested to have a very strong average seal strength of about 5000 to 5400 grams. The bag also had an average M.D. and T.D. heat shrinkability at 90° C. of 42 and 48, respectively. The ram puncture results were likewise impressive. The puncture resistance of the 6.9 mil thick inventive film was measured and the combined tube member wall and outer film member was punctured using a ram puncture tester apparatus by positioning the film with the inner surface of the tube member wall proximate the striker prior to impact. The about 7 mil wall thickness had a maximum puncture force of 270.6 Newtons (N) and a total energy to failure of 2.836 Joules (J). The individual tube film and outer film members were tested for puncture resistance. The seamless tube member had an average maximum force of 121.1 Newtons; and a total energy to failure(maximum force) of 1.212 Joules; and the outer film member had corresponding values of: 198.4 N and 2.215 J. It is demonstrated by the above properties that a thick bag may be sealed hemetically to provide commercially acceptably strong heat seals in a puncture resistant bag. This preferred bag has very good heat shrink percentages which are highly desirable for packaging bone-in cuts of fresh red meat and extremely good puncture resistance. Thus an economical to produce heat shrinkable bag having complete patchless puncture resistance and strong seals with an interiorly seamless end sealed tube has been made having a unique combination of features and commercial advantages previously unknown.

A further advantage of the invention is that either or both sides of the tube member may be printed, or the mating surface of either or both of the outer film members may be printed and the print may thus be protected from contact with either enclosed product such as food, or protected from exposed surface wear, abrasion or conditions which may have a deleterious effect upon the print quality or appearance. Special effects may also be obtained by printing on surfaces trapped between layers as well as exterior surfaces in combination.

While this invention has been described with reference to certain specific embodiments, it will be recognized by those skilled in the art that many variations are possible without departing from the scope and spirit of the invention and such variations are deemed to be within the scope of the invention claimed below.

What is claimed is:

1. A puncture-resistant end sealed bag comprising:
(a) a seamless tube member having a first tube wall and an opposed second tube wall;
(b) a product receiving chamber defined between said first and second tube walls;
(c) a first outer film member affixed to an outer surface of said first tube wall and covering the entire surface area of said first tube wall;
(d) a second outer film member affixed to an outer surface of said second tube wall and covering the entire surface area of said second tube wall;
(e) a first lateral seal provided through said first and second tube walls and said first and second outer film members, said seal extending laterally across at least the width of said tube member.

2. The bag of claim 1, wherein said first outer film member and said second outer film member extend laterally beyond the side edges of said first and second tube walls and said first outer film member and said second outer film member are affixed to each other along both side edges of said bag.

3. The bag of claim 1, wherein each of said first tube wall and said second tube wall of said tube member have a total thickness from 1.5 mil to 4.0 mil.

4. The bag of claim 1, wherein said first outer film member is a monolayer film having a total thickness from about 2.0 mil to about 6.0 mil.

5. The bag of claim 1, wherein said second outer film member is a monolayer film having a total thickness from 2.0 mil to 6.0 mil.

6. The bag of claim 1, wherein said first outer film member and said second outer film member are substantially identical and are monolayer films each having a total thickness from about 2.0 mil to 6.0 mil.

7. The bag of claim 1, wherein at least one of said tube member, said first outer film member and said second outer film member is a heat shrinkable film having at least 20% shrink at 90° C. in at least one direction.

8. The bag of claim 7, wherein said tube member comprises a multilayer film having an inner heat sealing layer, a core layer and an outer layer.

9. The bag of claim 8, wherein said core layer comprises a polymer selected from the group consisting of vinylidene chloride copolymer, vinylidene chloride-vinyl chloride copolymer, vinylidene chloride-methyl acrylate copolymer, ethylene-vinyl alcohol copolymer, polyamide and blends thereof.

10. The bag of claim 8, wherein said inner heat sealing layer comprises a blend of: (i) at least one ethylene-alpha-olefin copolymer; and (ii) a copolymer of ethylene with a vinyl ester or alkyl acrylate.

11. The bag of claim 8, wherein said outer layer comprises a blend of: (i) at least one ethylene-alpha-olefin copolymer; and (ii) a copolymer of ethylene with a vinyl ester or alkyl acrylate.

12. The bag of claim 7, wherein said first and said second outer film members include a monolayer film comprising a blend of: (i) at least one ethylene-α-olefin copolymer; and (ii) ionomer polymer.

13. The bag of claim 1, wherein said tube member comprises a multilayer biaxially oriented shrink film including an inner heat sealing layer, a core layer and an outer layer; said inner layer comprising a blend of: (i) at least one ethylene-α-olefin copolymer; and (ii) at least one copolymer of ethylene with a vinyl ester or alkyl acrylate; said core layer comprising a polymer selected from the group consisting of vinylidene chloride copolymer, vinylidene chloride-vinyl chloride copolymer, vinylidene chloride-methyl acrylate copolymer, ethylene-vinyl alcohol copolymer, polyamide and blends thereof; the outer layer comprising a blend of: (i) at least one ethylene-α-olefin copolymer; and (ii) copolymer of ethylene with a vinyl ester or alkyl acrylate; said first and said second outer film members each comprise a monolayer biaxially oriented shrink film comprising a blend of: at least one ethylene-α-olefin copolymer; and (ii) an ionomer; and wherein said first and said second outer film members are affixed to the tube member by a surface energy treatment.

14. A method of forming a puncture-resistant bag for packaging bone-in cuts of meat comprising the steps of::
(a) providing a continuous lay-flat tube film, said lay-flat tube film having a first tube wall and an opposed second tube wall, and a first tube edge and an opposed second tube edge;
(b) affixing a first outer film member to an outer surface of said first tube wall and covering the entire surface area of said first tube wall;
(c) affixing a second outer film member to an outer surface of said second tube wall and covering the entire surface area of said second tube wall;
(d) providing a first lateral seal through said first and second tube walls and said first and second outer film members, said seal extending laterally across the width of said tube member; and
(e) providing a cut laterally through said first and second tube walls and said first and second outer film members, said cut extending laterally across at least the width of both said first and second outer film members.

15. The method of claim 14, wherein said first and second outer film members extend laterally beyond said first and second tube edges, said first and second outer film members being affixed to each other beyond said first and second tube edges.

16. The method of claim 14, wherein said first and second outer film members are affixed to the lay-flat tube film by a process selected from surface energy treatment, adhesive lamination, and extrusion lamination.

17. The method of claim 14, wherein said first and second outer film members are affixed to the lay-flat tube film by corona discharge treatment.

18. The method of claim 14, wherein said lay-flat tube film is formed by coextruding a film tube, cooling the film tube, collapsing the film tube, inflating the film tube, reheating the inflated film tube, biaxially stretching the film tube, cooling and re-collapsing the film tube to produce a biaxially oriented film.

19. The method of claim 14, wherein each of said lay-flat tube film and said first and second outer film members comprise biaxially oriented shrink films.

20. A puncture-resistant bag including:
(a) a seamless tube member having a first tube wall and an opposed second tube wall; said first and second tube walls having a first tube end and an opposed second tube end and a first seamless tube edge and an opposing second seamless tube edge;
(b) a first outer film member affixed to an outer surface of said first tube wall, said first outer film member extending continuously between said first and second tube ends;
(c) a second outer film member affixed to an outer surface of said second tube wall, said first outer film member extending continuously between said first and second tube ends; and
(d) a first lateral seal provided through said first and second tube walls, said seal extending laterally across the width of said tube member.

21. The bag of claim 20, wherein said first lateral seal is provided through said first and second outer film members.

22. The bag of claim 20, wherein the tube member comprises a film selected from the group of monolayer and multilayer films having a total thickness from 1.5 mil to 4.0 mil.

23. The bag of claim 20, wherein said first outer film member comprises a film selected from the group of monolayer and multilayer films having a total thickness from 2.0 mil to 6.0 mil.

24. The bag of claim 20, wherein said second outer film member comprises a film selected from the group of monolayer and multilayer films having a total thickness from 2.0 mil to 6.0 mil.

25. The bag of claim 20, wherein said first outer film member and second outer film member comprise a substantially identical film selected from the group of monolayer and multilayer films having a total thickness from 2.0 mil to 6.0 mil.

26. The bag of claim 20, wherein said lay-flat tube member, said first outer film member and said second outer film member are selected from the group consisting of monolayer, biaxially oriented, heat shrink films and multilayer, biaxially oriented, heat shrink films.

27. The bag of claim 26, wherein said tube member comprises a multilayer film having an inner heat sealing layer, a core layer and an outer layer.

28. The bag of claim 26, wherein said tube member comprises a multilayer film having an inner heat sealing layer, a first intermediate layer, a core layer, a second intermediate layer, and an outer layer.

29. The bag of claim 27, wherein said core layer comprises a polymer selected from the group consisting of vinylidene chloride copolymer, vinylidene chloride-vinyl chloride copolymer, vinylidene chloride-methyl acrylate copolymer, ethylene-vinyl alcohol copolymer, polyamide and blends thereof.

30. The bag of claim 27, wherein said inner heat sealing layer comprises at least one ethylene-alpha-olefin copolymer.

31. The bag of claim 27, wherein said outer layer comprises at least one ethylene-alpha-olefin copolymer.

32. The bag of claim 26, wherein said first and second outer film members comprise a monolayer film comprising a at least one ethylene-α-olefin copolymer.

33. The bag of claim 20, wherein said tube member comprises a multilayer biaxially oriented shrink film including an inner heat sealing layer, a core layer and an outer layer; said inner layer comprising at least one ethylene-α-olefin copolymer; said core layer comprising a polymer selected from the group consisting of vinylidene chloride copolymer, vinylidene chloride-vinyl chloride copolymer, vinylidene chloride-methyl acrylate copolymer, ethylene-vinyl alcohol copolymer, polyamide and blends thereof; said outer layer comprising at least one ethylene-α-olefin copolymer; said first and second outer film members each comprise a biaxially oriented shrink film comprising at least one ethylene-α-olefin copolymer; and wherein at least one of said first and second outer film members are affixed to said lay-flat tube member by a high energy surface treatment method.

34. The bag of claim 20, wherein said tube member comprises a multilayer biaxially oriented shrink film including an inner heat sealing layer, a core layer and an outer layer; said inner layer comprising at least one ethylene-α-olefin copolymer; said core layer comprising a polymer selected from the group consisting of vinylidene chloride copolymer, vinylidene chloride-vinyl chloride copolymer, vinylidene chloride-methyl acrylate copolymer, ethylene-vinyl alcohol copolymer, polyamide and blends thereof; said outer layer comprising at least one ethylene-α-olefin copolymer; said first and second outer film members each comprise a biaxially oriented shrink film comprising at least one ethylene-α-olefin copolymer; and wherein at least one of said first and second outer film members are affixed to said lay-flat tube member by a chemical adhesive.

35. The bag of claim 33, wherein said first and second outer film members are affixed to each other along at least one side edge of said tube member by a high energy surface treatment method or a chemical adhesive.

36. The bag of claim 34, wherein said first and second outer film members are affixed to each other along at least one side edge of said tube member by a high energy surface treatment method or a chemical adhesive.

37. The bag of claim 33, wherein said first and second outer film members further comprise an ionomer.

38. The bag of claim 34, wherein said first and second outer film members further comprise an ionomer.

39. The bag of claim 20, wherein said first outer film member and said second outer film member comprise a continuous film of at least one layer and said continuous film wraps around at least one edge of said first and said second tube walls.

40. The bag of claim 20, wherein said first tube wall and said second tube wall and said first and second outer film members have a combined thickness of at least 6 mil through which said seal is made.

41. The bag of claim 20, wherein said first tube wall and said second tube wall and said first and second outer film members have a combined thickness of at least 7 mil through which said seal is made.

42. The bag of claim 20, wherein said first tube wall and said second tube wall and said first and second outer film members have a combined thickness of at least 10 mil through which said seal is made.

43. The bag of claim 20, wherein said first tube wall and said second tube wall and said first and second outer film members have a combined thickness of at least 12 mil through which said seal is made.

44. The bag of claim 20, wherein said bag has an oxygen gas transmission rate of less than 45 cm³ per m² in 24 hours at 1 atmosphere at a temperature of 23° C. and 0% relative humidity.

45. The bag of claim 20, wherein said lay flat tube member, said first outer film member, and said second outer film member all comprise heat shrinkable films having at least 40% shrink in at least one direction.

46. The bag of claim 20, wherein said lay flat tube member, said first outer film member, and said second outer film member all comprise films having less than 10% shrink in at both directions.

47. The bag of claim 20, wherein at least one of said lay flat tube member, said first outer film member, and said second outer film member comprise at least one layer selected from the group consisting of metallized polymeric film, unmetallized polymeric film, metal foil, polyamide, ionomer, metallized polyester, polypropylene, propylene ethylene copolymer, and aluminum foil.

48. The bag of claim 20, wherein said seal is linear.

49. The bag of claim 20, wherein said seal is curved.

50. The bag of claim 20, wherein said seal has a seal strength of at least 3000 g.

51. The bag of claim 20, wherein said seal has a seal strength of at least 4000 g.

52. The bag of claim 20, wherein said seal has a seal strength of at least 5000 g.

53. The bag of claim 20, wherein at least one of said first and second outer film members has an elongation at break greater than 200% at RT .

54. The bag of claim 20, wherein at least one of said first and second outer film members has an elongation at break greater than 250%.

55. The bag of claim 20, wherein at least one of said first and second outer film members has an elongation at break greater than 300 .

56. The bag of claim 20, wherein at least one said first and said second outer film members has a 1% secant modulus value of less than 20,000 psi in at least one direction.

57. The bag of claim 20, wherein at least one said first and said second outer film members has a 1% secant modulus value of less than 17,500 psi in at least one direction.

58. The bag of claim 20, wherein at least one said first and said second outer film members has a 1% secant modulus value of less than 15,000 psi in at least one direction.

59. A method of forming a puncture-resistant bag for packaging bone-in cuts of meat comprising the steps of:
(a) providing a continuous lay-flat tube film, said lay-flat tube film having a first tube wall and an opposed second tube wall and a first tube edge and an opposed second tube edge;
(b) affixing a first outer film member to an outer surface of said first tube wall;
(c) affixing a second outer film member to an outer surface of said second tube wall;
(d) providing a first lateral seal through said first and second tube walls and said first and second outer film members, said seal extending laterally across the width of said tube member; and
(e) providing a cut laterally through said first and second tube walls and said first and second outer film members, said cut extending laterally across the width of both said first and second outer film members and said lay-flat tube member, whereby a bag is formed having a bag mouth on one end formed by said cut and having said heat seal proximate a bag end at an opposing end from said bag mouth, and wherein said first and second outer film members extend continuously between said first lateral seal and said cut.

60. The method of claim 59, wherein said first and second outer film members are affixed to said lay-flat tube film by a process selected form surface energy treatment, adhesive lamination, and extrusion lamination.

61. The method of claim 59, wherein said first and second outer film members are affixed to said lay-flat tube film by corona discharge treatment.

62. The method of claim 59, wherein said lay-flat tube film is formed by coextruding a film tube, cooling said film tube, collapsing said film tube, inflating said film tube, reheating said inflated film tube, biaxially stretching said film tube and re-collapsing said film tube to produce a biaxially oriented lay-flat tube film.

63. The method of claim 59, wherein each of said lay-flat tube film and said first and second outer film members comprise biaxially oriented shrink films.

64. The method of claim 59, wherein said first and second outer film member are formed by coextruding a film tube, cooling said film tube, collapsing said film tube, inflating said film tube, reheating said inflated film tube, biaxially stretching said film tube, cooling said stretched film tube and longitudinally slitting said film tube to produce a biaxially oriented film.

65. The method of claim 59, wherein said cut forming said mouth is provided prior to providing said first lateral seal.

66. The method of claim 59, wherein said cut forming said mouth is provided after providing said first lateral seal.

67. The method of claim 59, wherein said seal is curved.

68. A continuous method of forming a puncture-resistant bag tube stock for forming end-seal puncture-resistant bags comprising the steps of:
(a) providing a continuous, seamless lay-flat tubular film, said lay-flat tubular film having a first tube wall and an opposed second tube wall, and a first tube edge and an opposed second tube edge;
(b) affixing a continuous first outer film member to an outer surface of said first tube wall and affixing a continuous second outer film member to an outer surface of said second tube wall to form a composite structure;
(c) winding said composite structure onto a reel.

69. The method of claim 68, wherein said first and second outer film members cover substantially the entire outer surfaces areas of said first and said second tube walls.

70. The method of claim 68, wherein said first and second outer film members extend transversely beyond said first and second tube edges and are affixed to each other.

71. The method of claim 68, wherein said first and second outer film members are affixed to said lay-flat tubular film substantially simultaneously.

72. The method of claim 68, wherein the step of affixing said first and second outer film members is a two step process wherein said first outer film member is first affixed to said first tube wall to form an intermediate composite structure; said intermediate composite structure is wound on a reel; and said second outer film member is affixed thereafter.

73. The method of claim 68, wherein said first outer film member and said second outer film member comprise a continuous film of at least one layer and said continuous film wraps around at least one of said edges of said first and said second tube walls.

74. A bag tube stock composite structure comprising;
(a) a seamless tube member having a first tube wall and an opposed second tube wall; said first and second tube walls having a first tube end and an opposed second tube end and a first seamless tube edge and an opposing second seamless tube edge;
(b) a first outer film member affixed to an outer surface of said first tube wall, said first outer film member extending continuously between said first and second tube ends;
(c) a second outer film member affixed to an outer surface of said second tube wall, said first outer film member extending continuously between said first and second tube ends.

75. A bag tube composite structure, as defined in claim 74 wherein said first and second outer film members completely cover said first and second tube walls.

76. A bag tube composite structure, as defined in claim 74 wherein said first and second outer film members extend past said first and second tube edges and said are affixed together adjacent to said first and second tube edges .

77. A bag tube composite structure, as defined in claim 74 wherein said first and second outer film members and said tube member are all heat shrinkable films.

78. A bag tube composite structure, as defined in claim 74 wherein at least one of said first and second outer film members and said tube member has less than 10% shrink at 90° C. in both M.D. and T.D. directions.

79. A bag tube composite structure, as defined in claim 74 wherein at least one said first and second outer film members and said tube member comprises at least one layer selected from the group consisting of metallized polymeric film, unmetallized polymeric film, metal foil, polyamide, ionomer, metallized polyester, polypropylene, propylene ethylene copolymer, ethylene alpha-olefin copolymer, ethylene vinyl ester copolymer, ethylene alkyl acrylate copolymer and aluminum foil.

80. A bag tube composite structure, as defined in claim 74, wherein said tube member comprises a multilayer film having at least five layers.

81. A bag tube composite structure, as defined in claim 75, wherein at least one of said first and second outer film members has an elongation at break of at least 200% at RT.

82. A bag tube composite structure, as defined in claim 75, wherein at least one of said first and second outer film members has a 1% secant modulus value of less than 20,000 psi.

83. A bag tube composite structure, as defined in claim 75, wherein at least one of said first and second outer film members has a 1% secant modulus value of less than 17,500 psi.

84. A bag tube composite structure, as defined in claim 75, wherein said first tube wall and said second tube wall and said first and second outer film members have a combined thickness of at least 7 mil.
